(19) United States
(12) Patent Application Publication
(10) Pub. No.: US 2012/0187666 A1
(43) Pub. Date: Jul. 26, 2012

(54) Airbag systems to affect restrained occupant kinematics and associated neck loads during rollover impact conditions

(76) Inventor: Keith Friedman, Austin, TX (US)

(21) Appl. No.: 13/355,152

(22) Filed: Jan. 20, 2012

Related U.S. Application Data
(60) Provisional application No. 61/461,651, filed on Jan. 21, 2011.

(51) Int. Cl. B60R 21/213

(52) U.S. Cl. 280/730.2

(57) ABSTRACT

A rollover safety system for vehicles. The system includes a rollover sensor, which generates a signal in response to a rollover condition. The signal is used to deploy low pressure, slow deployment roof/roof-rail airbags and door airbags. Novel configurations from single short throw roof/roof-rail airbags to combination long throw roof/roof-rail and door airbags have been shown to significantly reduce injuries to the head and neck when used with existing side curtain/passenger restraint systems compared to those systems alone. The slow nature of rollover accidents allows for slow deployment at lower pressure greatly reducing the potential of injury from deployment compared to impact safety airbags

### RELATED APPLICATIONS

This application claims priority to U.S. Provisional Application Ser. No. 61/461/651, filed Jan. 21, 2011

### FEDERALLY SPONSORED RESEARCH

Not Applicable

### SEQUENCE LISTING

Not Applicable

### BACKGROUND OF THE INVENTION

The invention relates to occupant safety in a moving vehicle and in particular to a novel system for improving occupant safety in a rollover accident.

Serious head and neck injuries in rollover crashes have been associated with contacts related to the roof rail area. With the incorporation of side curtains there is still concern that the head may be in contact with the roof rail area in a rollover. Some manufacturers have claimed that their design approach using side curtains and pre-tensioned belts are not reducing the trailing side occupant neck loads and in some cases are increasing them under certain test conditions.

In a rollover impact it would be advantageous to keep an occupant's head, neck and torso as far away as possible from roof structure, and, in particular, roof structure which intrudes into occupant space during the rollover impact. Previous efforts have shown the ability of seat-based systems to move the head away from roof contact during rollover events with substantial reductions in neck and head injury measures, such as described in U.S. Pat. Nos. 7,278,682, 7,216,931, and 7,644,799, incorporated by reference in their entirety. Such measures are effective, but other approaches may also have advantages.

Airbags have been traditionally used to cushion impacts or block ejection portals. However to date no one has produced airbag based designs to reposition the occupant away from the hazards associated with roof intrusion and head positioning near the roof rail in a rollover event. Thus it is the object of this invention to provide a safety system for rollover events based on novel airbag positioning and deployment.

### BRIEF SUMMARY OF THE INVENTION

In one embodiment the invention is a vehicle rollover safety system to reduce occupant head/neck injury in a rollover accident, including a rollover sensor, and a short throw roof/roof-rail airbag disposed in the area above and to the outboard side of an occupants head when the occupant is properly secured in a vehicle seat. In response to a signal indicating a rollover is occurring, the airbag is deployed. The short throw roof/roof-rail airbag is typically a single or dual chamber airbag.

In another embodiment the invention is a vehicle rollover safety system to reduce occupant head/neck injury in a rollover accident, including a rollover sensor, and a long throw roof/roof-rail airbag disposed in the area above and to the outboard side of an occupants head when the occupant is properly secured in a vehicle seat. In response to a signal indicating a rollover is occurring, the airbag is deployed. The long throw roof/roof-rail airbag is typically a single or dual chamber airbag.

In either of the above embodiments, the invention may include a long throw door airbag disposed to the side of the occupant properly secured in the vehicle seat. The door airbag is typically a dual chamber airbag.

In all embodiments, the deployment time of the airbag is preferably greater than 100 msec. In all embodiments, the deployment pressure of the airbag is preferably less than that of more aggressive airbags used for more acute impacts for impact protection.

In embodiments including a door airbag, the deployment pressure of the door airbag is less than that of airbags for more aggressive impacts but higher than the roof/roof-rail airbag. It should be clear that reductions in injuries to the torso and other body parts are also possible given the system's design intent to move the occupant away from potentially injurious impact surfaces and/or occupant impact orientations.

### BRIEF DESCRIPTION OF THE DRAWINGS

The invention will be better understood by referring to the following figures.

FIG. 1 shows a simulated view of occupant head position in a rollover event without the benefits of the invention.

FIG. 2 shows exemplary placement of the novel airbags according to the invention.

FIG. 3 shows a simulated view of occupant head position when a short throw roof/roof-rail airbag is employed.

FIG. 4 shows a simulated view of occupant head position when a short throw roof/roof-rail airbag is employed along with a long throw door airbag.

FIG. 5 shows a simulated view of occupant head position when a long throw roof/roof-rail airbag is employed.

FIG. 6 shows a simulated view of occupant head position when a long throw roof/roof-rail airbag is employed along with a long throw door airbag.

FIG. 7 is a table showing example test simulation results in improved occupant safety for the various embodiments of the invention.

### DETAILED DESCRIPTION OF THE INVENTION

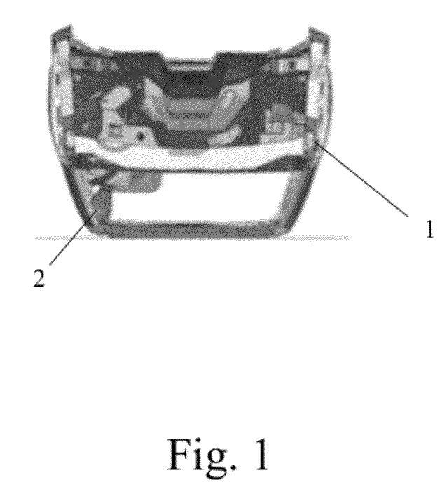

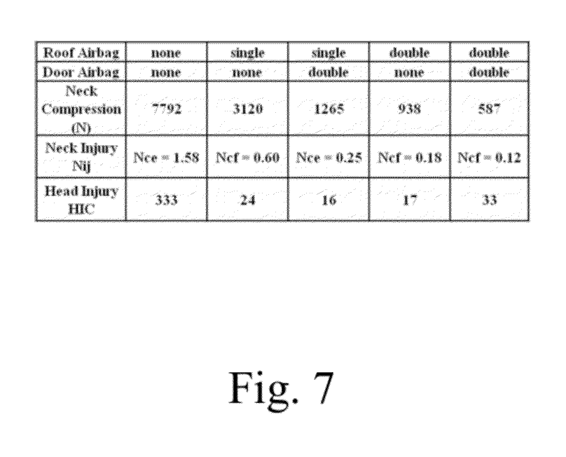

FIG. 1 illustrates a simulated baseline rollover impact. Due to lateral decelerations during leading and trailing side impacts with the ground, occupant's 2 head and torso tilts laterally towards the outboard side of vehicle 1 where significant roof intrusion may occur. In addition, in an ineffectively designed rollover occupant protection system, the torso and neck maybe aligned with the direction of impact and roof intrusion resulting in large neck loads. In this example, the baseline impact produced a peak upper neck compression force (Fz) of 7792 N with an Nij of 1.58 and an HIC of 333 as shown in FIG. 7.

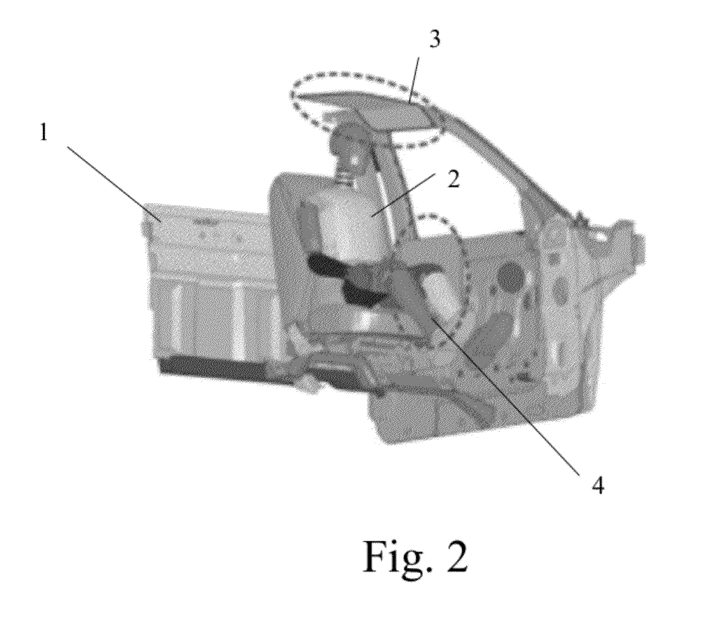

The elements of the invention are shown in FIG. 2. A short throw (single chamber) bag or long throw (dual chamber) bag were incorporated in the roof/roof rail area 3. Short or preferably long throw compartment airbags 4 deploying from the door panel are also shown. The roof and door bags as tested by the inventors have a footprint that is approximately 0.2 square meters under the headliner and on the door panel respectively each with a volume of about 22 liters although not in a regular shape. The fabric used was about 0.3 mm with an in plane along fiber modulus Ea of 0.215GPA. The roof bag pressure is very low to avoid any injury potential from deployment. Tethering was used in some cases to control shape; in some cases bags vent between each other. The roof-related bag pressures were fairly low, while the door mounted bags with higher pressures are used. In both cases, the inventor contemplates roof bag inflation pressures significantly lower than typical side curtain airbag pressures, whose pressures vary somewhat but are generally known in the art. Door bag pressures can be consistent with typical door bag pressure maximums but with less aggressive inflation rates, again generally known in the art. The positioning and airbag characteristics shown are for a particular vehicle configuration (small truck). The exact placement, sizes and pressures will depend on the vehicle configuration and those skilled in the art will recognize how to tailor the invention for particular vehicle configurations.

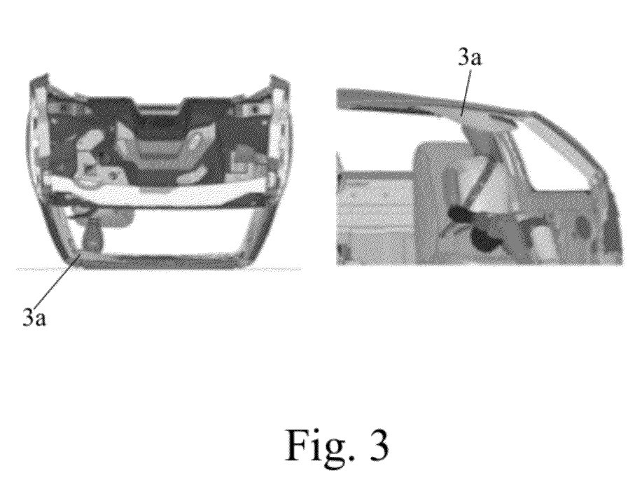

FIG. 3 shows the simplest version of the invention, the inclusion of a single chamber (short stroke) roof/roof-rail airbag 3a, which lays flat under the headliner, which restricts the movement of the head and torso towards the outboard side of vehicle during the near and far side rollover event affects. At the start of the rollover event, the driver neck and torso are not as well aligned with the impact/roof intrusion direction as they were in the baseline case. As a result, compared to the baseline case, the neck compression is reduced by more than 50%, the Nij by 60%, and the HIC was reduced by a factor of 10. Clearly even the simplest version produces significant results

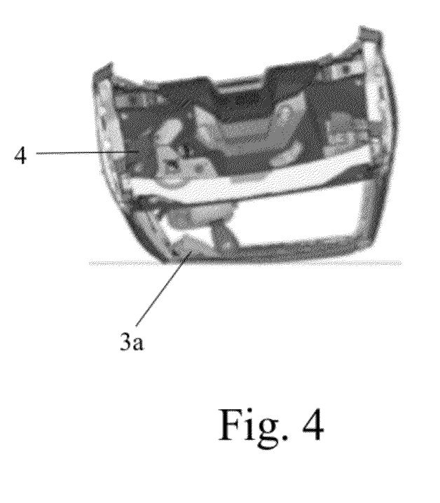

FIG. 4 shows the addition of a dual chamber (long stroke) airbag 4 in the door shoves the torso and head inboard towards the center of compartment prior to the trailing side impact. At the beginning of the trailing side event the dummy torso and neck is far from the outboard side of the vehicle and far out of alignment with the impact/intrusion direction. The result is an 80% reduction in neck compression, an 85% reduction in Nij and a 95% reduction in HIC compared to the baseline case.

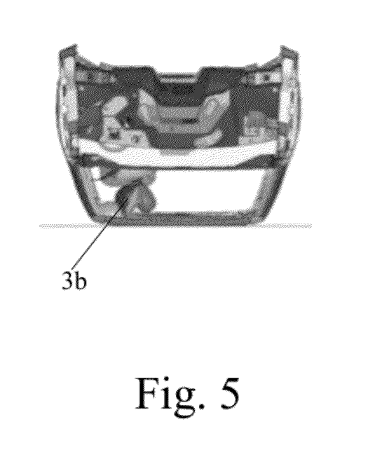

As shown in FIG. 5 employment of a long-stroke dual chamber roof/roof-rail airbag 3b alone achieves roughly the same result as the system comprised of a long stroke door airbag and a short stroke roof airbag. For this case, the compression neck loads and Nij was reduced by about 88% with respect to the baseline, and the HIC was reduced by 95%.

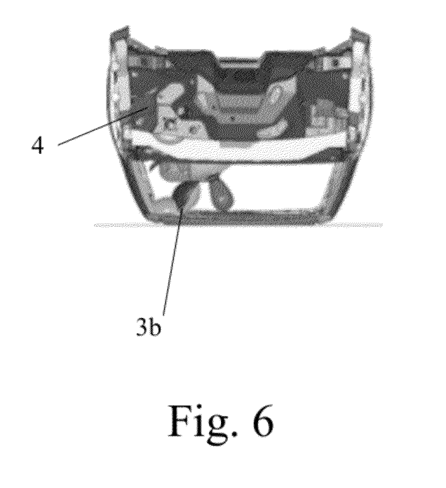

As shown in FIG. 6, a dual chamber roof/roof-rail bag 3b with the dual chamber door bag 4 results in highly desirable repositioning of the occupant head and torso away from the intrusion and the lowest neck and head loading of the systems tested (92% reduction in neck compression and Nij and a 90% reduction in the HIC). Incorporation of an alternative seat belt system, deployable shoulder bolsters, or a reduction in airbag displacements may be desirable modifications to this configuration.

FIG. 7 is a table showing the results of the various configurations of the invention compared to the baseline. All results shown are based on sophisticated modeling of various airbag configurations in a small truck experiencing typical rollover conditions with a standard test dummy model. The results are believed to be indicative of the improvements expected by employment of the embodiments of the invention. Of course the details are vehicle and occupant dependent but the inventor believes the safety improvements can be expected for most rollover scenarios in vehicles in which effective rollover protection system designs have not been incorporated

When a rollover event is detected and confirmed with the roll sensor system (possibly already present for the side curtains or added specifically for the invention) the roof and/or door bag systems could deploy then or later in the event. A rollover is a long duration event and there is adequate time for these bags to to reposition the head and torso so that the head does not become locked into the roof rail area, over a much longer time period (100's of msec as opposed to a few msec), and with airbags that are much less aggressive conventional impact airbags. Thus airbag-induced injuries should be much less. In essence, the interior of the vehicle compartment is being reconfigured to present a more benign environment to the occupant by reorienting the occupant relative to the compartment, intruding structure, and impact loads so that the occupant is in a more advantageous position. The repositioning airbag systems would likely deploy in rollover events only, as they would deploy too slowly to be effective in a side or front impact. However since the materials can be soft and flexible it is not expected that any significant negative effects would be experienced from their deployment.

It is clear that the airbags could deploy from different locations; the roof bag could be integrated into the side curtain to reduce parts counts. Repositioning airbags that deploy earlier in the roll event (e.g., at 45 degrees of roll) may also be desirable. These systems could also potentially cushion head and torso impacts while helping to prevent ejection.

The roof bag could integrate with the side curtain inflation system with regulation of pressures incorporated (side curtains are higher pressures than the roof bags contemplated); porting or multichamber inflators, valved/ported, time delayed, or more complex inflators systems could be utilized for an integrated inflator system that would supply both the side curtains and the roof airbags; also the roof bags could be integrated for packaging purposes with the side curtain materials to make a coupled bag for manufacturing and installation ease; the bags would each likely represent separate volumetric chambers and hence isolated with regard to gas source, or they could be connected via a valve that ensured that the appropriate pressures were maintained in each chamber. Although not investigated, it is possible that larger stroke side curtains could also provide benefit in rollover events. Likewise, the door bags, when side impact protection utilizing a door bag is already present, could be integrated into the door bag system in a fashion that worked as a rollover less aggressive airbag in some scenarios and in its normal aggressive mode in others.

The roof bags, intended to be one over each side occupant with a roof rail, could be connected together between sides. The roof bags could also be incorporated with the side curtain bags adding a large bulge at the roof rail to prevent occupant alignment with the roof rail; this can be in conjunction with a door type bag that would augment reorientation of the occupant. The control of the door and roof bags could come from control software that reads the rollover sensor and determines whether a rollover is going to occur. Conditions can be incorporated in the software that considers the occupant size, and location relative to the rollover direction. For example, selective activation and/or activation timing may be desirable. Such considerations could also take into account whether the occupant is a leading side or trailing side occupant, front or rear seat occupant, etc.

The long throw roof and door airbags contemplated are multi-chambered but single large chambered designs may be applicable as well. If multi-chambered, they may be designed to vent from one bag to the other or have the gas supplied separately. The inflator characteristics for the roof airbag (to allow integration with the side curtain) may incorporate a dual hybrid type design, or have two inflator modules incorporated in one container, or simply have a separate inflator for the roof airbag and one for the side curtain. In any case the gas is expected to be a cold type gas mixture allowing the bags to remain deployed for relatively long periods with the desired pressures say 6-10 seconds depending on deployment strategies used. The door bag inflator would likely be a hybrid type or cold gas type inflator to maintain pressures of the same 6-10 second period depending on deployment strategies used.

The airbag materials should preferably be coated to ensure that minimum leakage occurs over time; it is possible that a pressure release valve may be desirable depending on the implementation that maintains or allows pressure release under some conditions. The airbag material is preferably thin consistent with current side curtain thicknesses but strong enough to prevent failures during loading. Internal or external tethers or effective placed stitching may be utilized to achieve the desired shape.

The door airbag for it's most effective function, may require the window sill level be at an appropriate height to ensure effective loading of the occupant, consistent with the seat and seat belt systems and other elements being utilized in the occupant protection system or vehicle design. However, it is important that the bag act above the cg of the person and near the cg of the chest so as to create an inboard tipping rotation of the upper body.

The system is envisioned to be utilized by a restrained occupant and activated under that circumstance, ie occupant properly secured into a seat as envisioned by the vehicle designers. However, it may be found that activating even when the occupant is unrestrained may be desirable. It may also be desirable to deploy even when there is no occupant present, but there are other unrestrained occupants. It may also be found to be desirable not to deploy with certain size occupants, or to deploy with different bag pressures, timing or bag shapes depending on the size of the occupant. Shapes could be controlled by activation or control of one or more of the multiple chambers; Bag pressures could be controlled through the inflator based on occupant size and restraint configuration using software in a control module for the particular bag. Such regulation could be incorporated through use of multistage inflators, or orifice control, or valve control on the inflators controlled by the software in the control module.

The foregoing description of the embodiments of the present invention has shown, described and pointed out the fundamental novel features of the invention. It will be understood that various omissions, substitutions, and changes in the form of the detail of the systems and methods as illustrated as well as the uses thereof, may be made by those skilled in the art, without departing from the spirit of the invention. Consequently, the scope of the invention should not be limited to the foregoing discussions, but should be defined by appended claims.

1. A vehicle rollover safety system to reduce occupant head/neck injury in a rollover accident, comprising;
a rollover sensor; and,
a short throw roof/roof-rail airbag disposed in the area above and to the outboard side of an occupants head when the occupant is properly secured in a vehicle seat, wherein;
in response to a signal indicating a rollover is occurring, the airbag is deployed.

2. The system of claim 1 wherein the roof/roof-rail airbag is a single chamber airbag.

3. The system of claim 1 wherein the deployment time of the airbag is greater than 100 msec.

4. The system of claim 3 wherein at least one of the maximum deployment pressure of the roof airbag is less than that of side curtain airbags for collision protection or the inflation rate is less aggressive than airbag systems designed for more aggressive impacts with shorter durations.

5. A vehicle rollover safety system to reduce occupant head/neck injury in a rollover accident, comprising;
a rollover sensor; and,
a long throw roof/roof-rail airbag disposed in the area above and to the outboard side of an occupants head when the occupant is properly secured in a vehicle seat, wherein;
in response to a signal indicating a rollover is occurring, the airbag is deployed.

6. The system of claim 5 wherein the roof/roof-rail airbag is a dual chamber airbag.

7. The system of claim 5 wherein the deployment time of the airbag is greater than 100 msec.

8. The system of claim 7 wherein at least one of the maximum deployment pressure of the roof airbag is less than that of side curtain airbags for collision protection or the inflation rate is less aggressive than airbag systems designed for more aggressive impacts with shorter durations.

9. The system of claim 1 further comprising a long throw door airbag disposed to the side of the occupant properly secured in the vehicle seat.

10. The system of claim 9 wherein the door airbag is a dual chamber airbag.

11. The system of claim 9 wherein the deployment time of the airbag is greater than 100 msec.

12. The system of claim 9 wherein at least one of the maximum deployment pressure of the roof airbag is less than that of side curtain airbags for collision protection or the inflation rate is less aggressive than airbag systems designed for more aggressive impacts with shorter durations but the deployment pressure is higher than the roof/roof-rail airbag.

13. The system of claim 5 further comprising a long throw door airbag disposed to the side of the occupant properly secured in the vehicle seat.

14. The system of claim 13 wherein the door airbag is a dual chamber airbag.

15. The system of claim 13 wherein the deployment time of the airbag is greater than 100 msec.

16. The system of claim 13 wherein at least one of the maximum deployment pressure of the roof airbag is less than that of side curtain airbags for collision protection or the inflation rate is less aggressive than airbag systems designed for more aggressive impacts with shorter durations but the deployment pressure is higher than the roof/roof-rail airbag.
